(19) United States
(12) Patent Application Publication
(10) Pub. No.: US 2026/0195531 A1
(43) Pub. Date: Jul. 9, 2026

(54) Creating Textual Output with the Writing Style of a Specific User Using Generative Artificial Intelligence

(71) Applicant: Microsoft Technology Licensing, LLC, Redmond, WA (US)

(72) Inventors: Anna VICKERS, Dublin (IE); Adrian DE WYNTER, Boston, MA (US); Enrico CADONI, Dublin (IE); Tao GE, Beijing (CN); Zhang LI, Sammamish, WA (US); Xun WANG, Amherst, MA (US); Si-Qing CHEN, Bellevue, WA (US)

(73) Assignee: Microsoft Technology Licensing, LLC, Redmond, WA (US)

(21) Appl. No.: 18/292,998

(22) PCT Filed: Sep. 1, 2022
(86) PCT No.: PCT/CN2023/116441

§ 371 Date: Jan. 29, 2024

(51) Int. Cl. G06F 40/253; G06F 16/3329

(52) U.S. Cl. CPC G06F 40/253; G06F 16/33295

(57) ABSTRACT

A data processing system implements receiving, from an application of a client device of a user, a request for content to be generated by a language model. The request includes a natural language prompt describing the content to be generated and an identifier of the user. The system further implements executing a query on one or more sample content sources to obtain sample content items authored at least in part by the user, constructing a prompt for the language model based on the natural language prompt and the sample content items, the prompt instructs the language model to mimic the writing style of the user based on the one or more sample content items, providing the prompt as an input to the language model to obtain the content, providing the content to the application of the client device, and causing the application to present the content in the application.

### BACKGROUND

Large language models (LLMs) are capable of generating complex text in response to user prompts. However, the text generated by the LLMs is often generic and lacks the specific “voice” of the user that represents the user's unique writing style. The model-generated text typically lacks the tone, word choices, sentence structure, and/or other stylistic choices that make the textual content sound as though the content were written by the user. Consequently, the content may appear to readers to be generated using artificial intelligence (AI) rather than by a human user. Furthermore, the style of the model-generated textual content may stand out stylistically when compared to content authored by the user. Therefore, using model-generated content to create content to be included in a document or other electronic content that has been authored in part by the user may result in content that lacks stylistic coherency and is jarring to the reader. Hence, there is a need for improved systems and methods that provide a technical solution for using generative AI to create textual output that mimics the writing style of a specific user.

### SUMMARY

An example data processing system according to the disclosure includes a processor and a machine-readable medium storing executable instructions. The instructions when executed cause the processor alone or in combination with other processors to perform operations including receiving, from a first application of a first client device of a first user, a first request for first content to be generated by a language model, the first request including a natural language prompt describing the first content to be generated, the first request further comprising an identifier of the first user; executing a query on one or more sample content sources to obtain one or more sample content items authored at least in part by the first user; constructing a prompt for the language model based on the natural language prompt and the one or more sample content items using a prompt construction unit, the prompt construction unit receiving the natural language prompt and the one or more sample content items as an input and to output the prompt, the prompt construction unit constructing the prompt by appending the natural language prompt and at least a portion of the one or more sample content items with an instruction string, the instruction string comprising instructions to the language model to mimic a writing style of the first user in the first content based on the one or more sample content items; providing the prompt as an input to the language model to obtain the first content; providing the first content to the first application of the first client device; and causing the first application to present the first content in a user interface of the first application.

An example method implemented in a data processing system includes receiving, from a first application of a first client device of a first user, a first request for first content to be generated by a language model, the first request including a natural language prompt describing the first content to be generated, the first request further comprising an identifier of the first user; executing a query on one or more sample content sources to obtain one or more sample content items authored at least in part by the first user; constructing a prompt for the language model based on the natural language prompt and the one or more sample content items using a prompt construction unit, the prompt construction unit receiving the natural language prompt and the one or more sample content items as an input and to output the prompt, the prompt construction unit constructing the prompt by appending the natural language prompt and at least a portion of the one or more sample content items with an instruction string, the instruction string comprising instructions to the language model to mimic a writing style of the first user in the first content based on the one or more sample content items; providing the prompt as an input to the language model to obtain the first content; providing the first content to the first application of the first client device; and causing the first application to present the first content in a user interface of the first application.

An example data processing system according to the disclosure includes a processor and a machine-readable medium storing executable instructions. The instructions when executed cause the processor alone or in combination with other processors to perform operations including receiving, from an application, a request for content to be generated by a language model, the request including a natural language prompt describing the content to be generated and an identifier of a user associated with the request; obtaining one or more sample content items that were authored at least in part by the user; constructing a prompt for the language model based on the natural language prompt and the one or more sample content items using a prompt construction unit, the prompt construction unit receiving the natural language prompt and the one or more sample content items as an input and to output the prompt, the prompt construction unit constructing the prompt by appending the natural language prompt and at least a portion of the one or more sample content items with an instruction string, the instruction string comprising instructions to the language model to generate textual content in a writing style of the user based on the portion of the one or more sample items; providing the prompt as an input to the language model to obtain the content; providing the content to the application; and causing the application to present the content in a user interface of the application.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram of an example computing environment in which the techniques for generating textual content that mimics the writing style of a particular user described herein are implemented.

FIGS. 2A-2C are diagrams of example user interfaces of an application that implements the techniques described herein.

FIG. 3 is a diagram showing additional features of the sample content unit of the application services platform shown in FIG. 1.

FIG. 4 is a diagram showing additional features of the prompt construction unit of the application services platform shown in FIG. 1.

FIG. 5 is an example of a prompt template that may be used by the prompt construction unit of the application services platform shown in FIGS. 1 and 4.

FIG. 6A is a flow chart of an example process for using generative AI to create textual content that mimics the writing style of a specific user according to the techniques disclosed herein.

FIG. 6B is a flow chart of another example process for using generative AI to create textual content that mimics the writing style of a specific user according to the techniques disclosed herein.

FIG. 7 is a block diagram showing an example software architecture, various portions of which may be used in conjunction with various hardware architectures herein described, which may implement any of the described features.

FIG. 8 is a block diagram showing components of an example machine configured to read instructions from a machine-readable medium and perform any of the features described herein.

### DETAILED DESCRIPTION

Systems and methods for using generative AI to create textual output that mimics the writing style of a specific user are described herein. These techniques provide a technical solution to the technical problem that content generated by language models typically lacks the tone, word choices, sentence structure, and/or other stylistic choices that make the textual content sound as though the content were written by the user. The techniques herein automatically identify and obtain sample content that was written by the user. The sample content reflects the writing style of the user and is used to provide context to the generative language model used to generate textual content in response to a prompt from the user. The sample content may include emails, various types of electronic documents and/or portions thereof drafted by the user, and/or other types of content authored by the user. The sample content provides examples of the tone, word choices, sentence structure, and/or other stylistic choices that are typically made by the user. The sample content is parsed and filtered to extract relevant portions of the sample content. The parsed and filtered sample content is combined with a natural language prompt to create a prompt that is provided to the generative language model. The generative language model then generates textual output that mimics the writing style of the user. A technical benefit of the approach provided herein is that the content generated by the generative language model more accurately represents the writing style of the user. Not only does this improve the output of the generative language model, but this approach can also decrease the computing resources required to obtain the generated content because the user is less likely to submit additional queries to the model to further refine the generated content. Another technical benefit of this approach is that the user can utilize the generative language model to assist the user in conveying their personal attitude and perspective to the audience of the content being generated. Another technical benefit is that this approach enables the user to maintain consistency and coherence in their writing voice in content authored by the user and content that is authored at least in part by using the generative language model. Yet another technical benefit of this approach can save the user significant time and effort by automatically generating textual content based on a prompt from the user based on the user's previous writing habits. These and other technical benefits of the techniques disclosed herein will be evident from the discussion of the example implementations that follow.

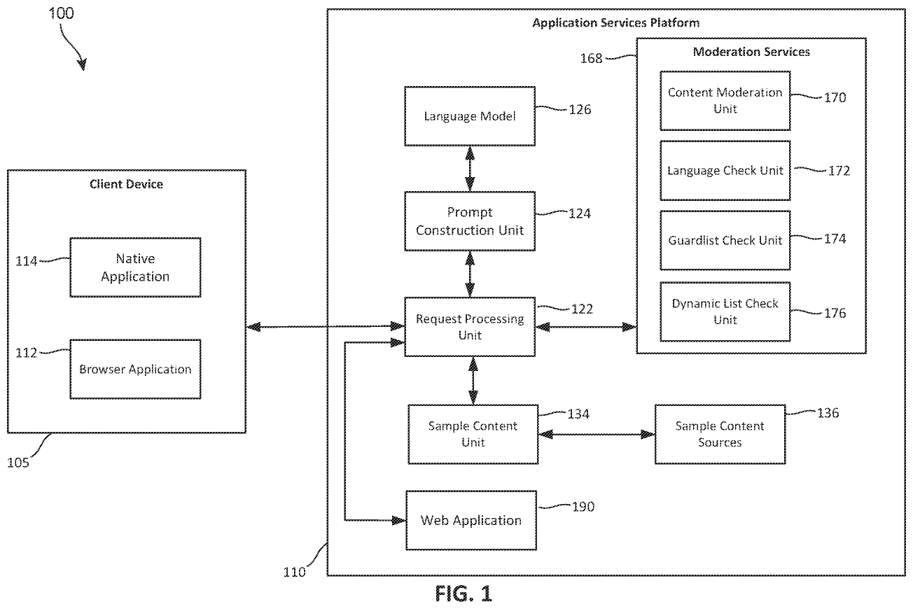

FIG. 1 is a diagram of an example computing environment 100 in which the techniques herein may be implemented. The example computing environment 100 includes a client device 105 and an application services platform 110. The application services platform 110 provides one or more cloud-based applications and/or provides services to support one or more web-enabled native applications on the client device 105. These applications may include but are not limited to word processing applications, presentation applications, web site authoring applications, collaboration platforms, communications platforms, and/or other types of applications in which users may create, view, and/or modify various types of electronic content. In the implementation shown in FIG. 1, the application services platform 110 also generates textual content that mimics the writing style of a user according to the techniques described herein. The client device 105 and the application services platform 110 communicate with each other over a network (not shown). The network may be a combination of one or more public and/or private networks and may be implemented at least in part by the Internet.

The client device 105 is a computing device that may be implemented as a portable electronic device, such as a mobile phone, a tablet computer, a laptop computer, a portable digital assistant device, a portable game console, and/or other such devices in some implementations. The client device 105 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 1 includes a single client device 105, other implementations may include a different number of client devices that utilize services provided by the application services platform 110.

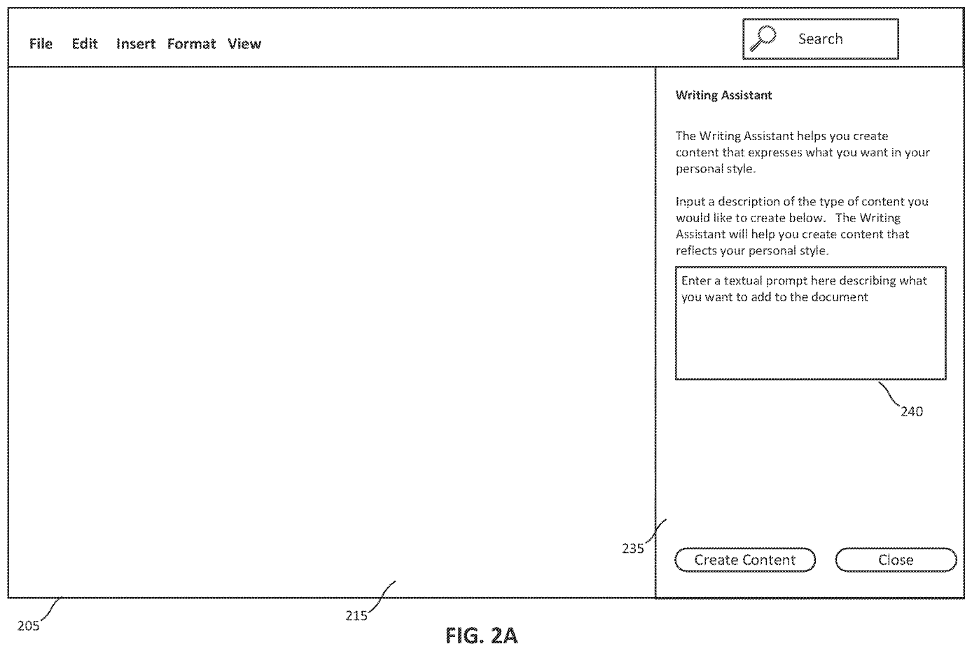

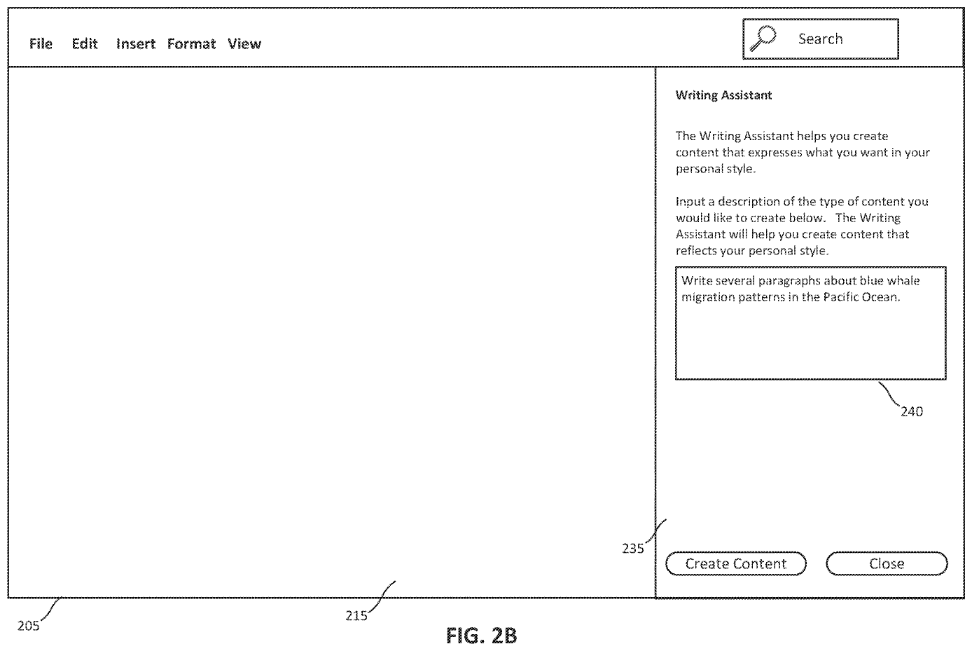

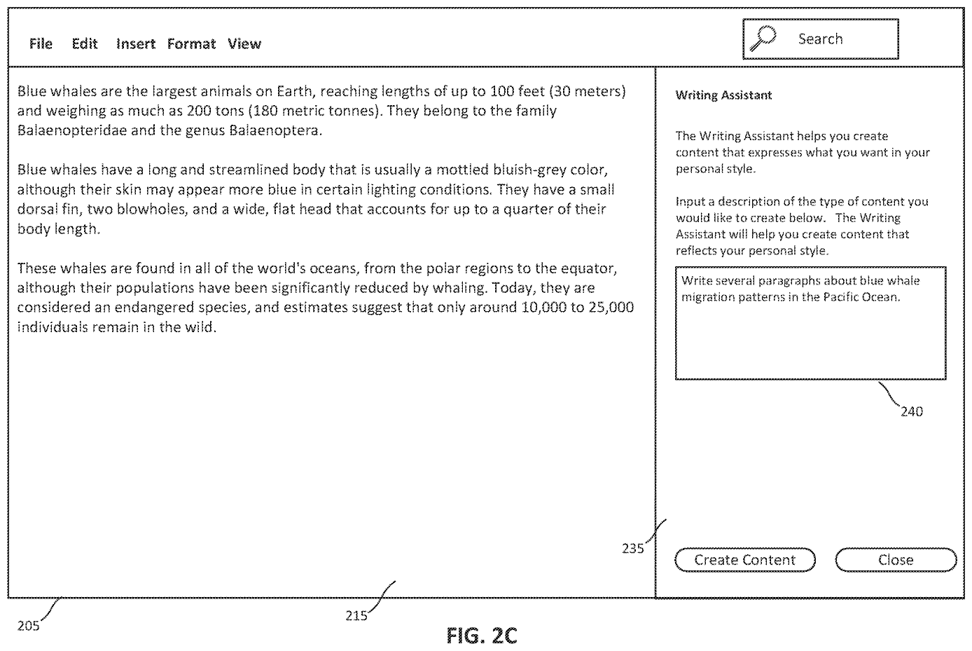

The client device 105 includes a native application 114 and a browser application 112. The native application 114 is a web-enabled native application, in some implementations, that enables users to view, create, and/or modify electronic content. The web-enabled native application utilizes services provided by the application services platform 110 including but not limited to creating, viewing, and/or modifying various types of electronic content and obtaining templates for creating and/or modifying the electronic content. The native application 114 implements the user interface 205 shown in FIGS. 2A-2C in some implementations. In other implementations, the browser application 112 is used for accessing and viewing web-based content provided by the application services platform 110. In such implementations, the application services platform 110 implements one or more web applications, such as the web application 190, that enables users to view, create, and/or modify electronic content and to obtain template recommendations for creating and/or modifying the electronic content. The web application implements the user interface 205 shown in FIGS. 2A-2C in some implementations. The application services platform 110 supports both the native application 114 and a web application 190 in some implementations, and the users may choose which approach best suits their needs.

The application services platform 110 includes a request processing unit 122, a prompt construction unit 124, a language model 126, a sample content unit 134, sample content sources 136, and the web application 190, and moderation services 168.

The request processing unit 122 is configured to receive requests from the native application 114 of the client device 105 and/or the web application 190 of the application services platform 110. The requests may include but are not limited to requests to create, view, and/or modify various types of electronic content and/or sending natural language prompts to the language model 126 to generate textual content according to the techniques provided herein. The request processing unit 122 also coordinates communication and exchange of data among components of the application services platform 110 as discussed in the examples which follow.

The language model 126 is a machine learning model trained to generate textual content in response to natural language prompts input by a user via the native application 114 or via the browser application 112. The language model 126 is implemented using a large language model (LLM) in some implementations. Examples of such models include but are not limited to a Generative Pre-trained Transformer 3 (GPT-3), or GPT-4 model. Other implementations may utilize other models or other generative models to generate textual content according to the writing style of the user.

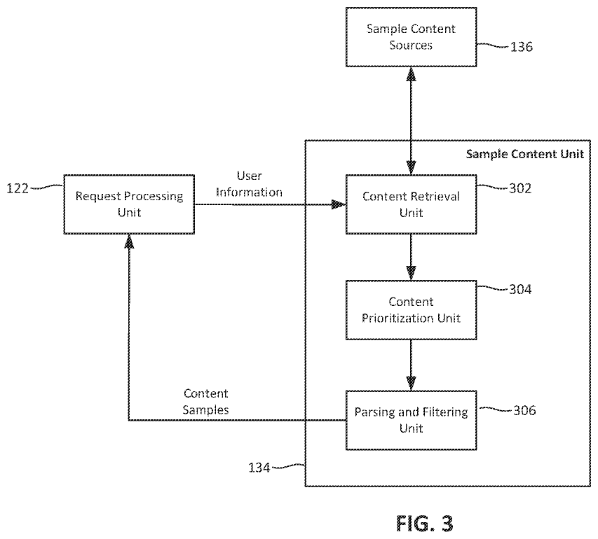

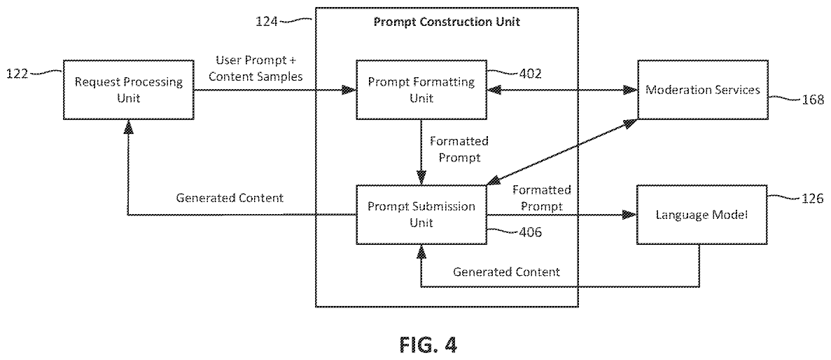

The request processing unit 122 receives a request to generate textual content from the native application 114 or the web application 190. The request includes a natural language prompt to generate textual content and an indication identifying the user submitting the natural language prompt. The natural language prompt provides a description of textual content that the user would like to have generated by the language model 126. The natural language prompt may specify a subject matter of the content to be generated, a type of content to be generated, and/or a length of the content to be generated. The user can specify various types of content to be generated including formal and/or informal textual content, such as but not limited to business documents, articles, stories, books, presentation content, and/or other types of textual content. The request includes an indication identifying the user for which the textual content is to be generated. The indication may be a username, email address, user identifier, and/or other identifier associated with the user that the application services platform 110 can use to identify the user and the sample content unit 134 can use to obtain sample content from the user that provides examples of the writing style of the user. The sample content unit 134 obtains samples of written content from one or more sample content sources 136. The sample content unit 134 provides the sample content obtained from the sample content sources 136 to the request processing unit 122. The sample content unit 134 parses and filters the sample content provided to extract relevant portions of the sample content and to format the content in a format that can be included in the prompt to the language model 126. Additional details of the sample content unit 134 are shown in FIG. 3, which is described in detail in the examples which follow. The request processing unit 122 provides the sample content and the natural language prompt input by the user as an input to the prompt construction unit 124. The prompt construction unit 124 constructs a prompt based on the natural language prompt and the sample content obtained from the sample content sources 136. Additional details of the prompt construction unit 124 are shown in FIG. 4, which is discussed in detail in the examples which follow. The prompt construction unit 124 may reformat or otherwise standardize the information to be included in the prompt to a standardized format that is recognized by the language model 126. The language model 126 is trained using training data in this standardized format, in some implementations, and utilizing this format for the prompts provided to the language model 126 may improve the predictions provided by the language model 126.

The moderation services 168 analyze the natural language prompt, textual content generated by the language model 126, and sample content obtained from the sample content sources 136 to ensure that potentially objectionable or offensive content is not generated or utilized by the application services platform 110. If potentially objectionable or offensive content is detected, the moderation services 168 provides a blocked content notification to the client device 105 indicating that the natural language prompt, the content generated by the language model 126, and/or the sample content included content that is blocked. In some implementations, the sample content unit 134 discards any sample content that includes potentially objectionable or offensive content and passes any remaining sample content that has not been discarded to the request processing unit 122 to be provided as an input to the prompt construction unit 124.

The moderation services 168 performs several types of checks on the electronic content item being accessed or modified by the user in the native application 114 or the web application 190, the natural language prompt input by the user, the sample content obtained from the sample content sources 136, and/or content generated by the language model 126. The content moderation unit 170 is implemented by a machine learning model trained to analyze the textual content of these various inputs to perform a semantic analysis on the textual content to predict whether the content includes potentially objectionable or offensive content. The language check unit 172 performs another check on the textual content using a second model configured to analyze the words and/or phrase used in textual content to identify potentially offensive language. The guard list check unit 174 is configured to compare the language used in the textual content with a list of prohibited terms including known offensive words and/or phrases. The dynamic list check unit 176 provides a dynamic list that can be quickly updated by administrators to add additional prohibited words and/or phrases. The dynamic list may be updated to address problems such as words or phrases becoming offensive that were not previously deemed to be offensive. The words and/or phrases added to the dynamic list may be periodically migrated to the guard list as the guard list is updated. The specific checks performed by the moderation services 168 may vary from implementation to implementation. If one or more of these checks determines that the textual content includes offensive content, the moderation services 168 can notify the application services platform 110 that some action should be taken.

In some implementations, the moderation services 168 generates a blocked content notification, which is provided to the client device 105. The native application 114 or the web application 190 receives the notification and presents a message on a user interface of the application that the request received by the request processing unit 122 could not be processed. The user interface provides information indicating why the blocked content notification was issued in some implementations. The user may attempt to refine the natural language prompt to remove the potentially offensive content. A technical benefit of this approach is that the moderation services 168 provides safeguards against both user-created and model-created content to ensure that prohibited offensive or potentially offensive content is not presented to the user in the native application 114 or the web application 190.

FIGS. 2A-2C are diagrams of example user interface 205 of an application that implements the techniques described herein. The example user interface shown in FIGS. 2A-2C is a user interface of a word processing application, such as but not limited to Microsoft Word®. However, the techniques herein for creating textual output that mimics the writing style of a specific user are not limited to use in a word processing application and may be used to generate content for other types of applications including but limited to presentation applications, web site authoring applications, collaboration platforms, communications platforms, and/or other types of applications in which users create, view, and/or modify various types of electronic content.

FIG. 2A shows an example of the user interface 205 of a word processing application in which the user is creating a new electronic document. The user interface 205 includes a content pane 215 and a writing assistant pane 235. The user interface 205 may be implemented by the native application 114 and/or the web application 190.

The content pane 215 provides a workspace in which the user can author an electronic document in the work processing application. In the example shown in FIG. 2A, the content pane 215 is empty, because the user has not yet begun authoring the electronic document. In some implementations, the writing assistant pane 235 is automatically presented on the user interface 205 when the user opens a new electronic document in the word processing application. The writing assistant pane 235 may be displayed in response to a user input, such as a keystroke combination or in response to the user activating a menu item or other user interface element on the user interface 205.

The writing assistant pane 235 enables the user to enter a natural language prompt in the prompt field 240. The natural language prompt describes content that the user would like to have automatically generated by the language model 126 of the application services platform 110. The application submits the natural language prompt to the application services platform 110 and user information identifying the user of the application to the application services platform 110. The application services platform 110 processes the request according to the techniques provided herein to generate textual content according to the writing style of the user. FIG. 2B shows an example of the user interface 205 in which the user has input a prompt in the prompt field 240. FIG. 2C shows an example of the user interface 205 in which the user has submitted the prompt by activating the “create content” control. The natural language prompt and the user information has been submitted to the application services platform 110, and the content generated by the language model 126 according to the writing style of the user is presented in the content pane 215 of the user interface 205. In some implementations, the user may submit further prompts requesting additional content to be generated and/or to further refine the content that has already been generated. The request processing unit 122 stores the sample content items included in prompt in some implementations for the duration of the user session in which the user uses the native application 114 or the web application 190. A technical benefit of this approach is that the sample content items do not need to be retrieved each time that the user submits a natural language prompt to generate content. The request processing unit 122 maintains user session information in a persistent memory of the application services platform 110 and retrieves the sample content items from the user session information in response to each subsequent natural language prompt submitted by the user. The request processing unit 122 then provides the newly received natural language prompt and the sample content items to the prompt construction unit 124 to construct the prompt as discussed in the preceding examples.

FIG. 3 is a diagram showing additional features of the sample content unit 134 of the application services platform shown in FIG. 1. The sample content unit 134 includes a content retrieval unit 302, a content prioritization unit 304, and a parsing and filtering unit 306. The request processing unit 122 provides user information identifying the user for which sample content is to be obtained from the sample content sources 136. The sample content sources 136 may include one or more sources of sample textual content written by users of the application services platform 110. In some implementations, the sample content sources 136 include email messages and/or other types of messages, various types of electronic documents, electronic publications, and/or other sources of sample content that has been created by users. The electronic documents are associated with metadata in some implementations that indicates which users authored the electronic documents and/or which users authored specific portions of the electronic documents for electronic documents which had multiple users contribute to the document. The sample content sources 136 are implemented on the application services platform 110 in some implementations. In other implementations, at least a portion of the sample content sources 136 are implemented on an external server that is accessible by the content retrieval unit 302 of the application services platform 110.

The application services platform 110 complies with privacy guidelines and regulations that apply to the usage of the user data included in the sample content sources 136 to ensure that that users have control over how the application services platform 110 utilizes their data. The user is provided with an opportunity to opt into the application services platform 110 being able to access the user data to enable the language model 126 to generate content according to the writing style of the user. In some implementations, the first time that an application, such as the native application 114 or the web application 190 presents the writing assistant to the user, the user is presented with a message that indicates that the user may opt into allowing the application services platform 110 to access user data from the sample content sources 136 to support the writing assistant functionality. The user may opt into allowing the application services platform 110 to access all or a subset of the sample content sources 136. Furthermore, the user may modify their opt-in status at any time by accessing their user profile information and selectively opting into or opting out of allowing the application services platform 110 from accessing and utilizing user data from the sample content sources 136 as a whole or individually.

The content retrieval unit 302 is configured to formulate a query to each of the sample content sources 136 based on the user information and to provide any sample content items retrieved to the content prioritization unit 304. In some implementations, the content retrieval unit 302 is configured to utilize the Microsoft Graph® platform or other similar platforms to access a graph associated with the user. The Microsoft Graph® platform provides an application programming interface (API) that enables the content retrieval unit 302 to query the data included in the graph associated with the user. The graph includes content associated with various cloud-based services that has been authored by and/or modified by the user, such as but not limited to Microsoft Word®, Microsoft Teams®, Microsoft OneDrive®, Microsoft Outlook®, and/or other cloud-based services. The graph may include enterprise-specific information associated with the user, projects associated with the enterprise, project teams within the enterprise, and/or the technologies implemented by the enterprise, such as enterprise-specific terminology, acronyms, project names, and/or other terminology that may be utilized in the sample content items authored by the user. A technical benefit of this approach is that the language model 126 is able to mimic the enterprise-specific terminology utilized by the user in the content generated by the model in addition to the stylistic aspects of the writing style of the user.

The content retrieval unit 302 is configured to perform a “graph walk” of the graph associated with the user to identify potential sample content items that have been authored by the user. The content retrieval unit 302 utilizes the Microsoft Graph® platform to obtain information from some content sources 136, while the content retrieval unit 302 utilizes other techniques to query other data sources which are not supported by the Microsoft Graph® platform in some implementations.

The content prioritization unit 304 receives the sample content items retrieved by the content retrieval unit 302 as an input. The content prioritization unit 304 prioritizes the sample content according to recency of the sample content items and the length of the sample content items. The content prioritization unit 304 ranks the sample content items according to these factors to determine which sample content items to select to include in the content samples that will be provided to the prompt construction unit 124. The writing style of a user may change over time, so more recent sample content items are preferred for providing the language model 126 with examples of the writing style of the user. Furthermore, longer sample content items provide more context for the user. In some implementations, the content prioritization unit 304 applies an equal weight to recency and length of the sample content items when ranking the sample content items. In other implementations, the content prioritization unit 304 applies a greater weight to the recency of the sample content items than to the length of the sample content items. In yet other implementations, the content prioritization applies a greater weight to the length of the sample content items than to the recency of the sample content items. The content prioritization unit 304 is configured to select a predetermined number of sample content items to be included in the content samples that will be provided to the prompt construction unit 124. If the number of sample content items is less that this predetermined number, then the content prioritization unit 304 includes all of the sample content items. The number of sample content items selected may be determined at least in part on the prompt size limits of the language model 126. Language models typically have a limit on the number of tokens that can be included in the prompt, which will limit the number of content samples that can be included in the prompt.

The parsing and filtering unit 306 receives the sample content items output by the content prioritization unit 304. The parsing and filtering unit 306 parses the sample content items to determine a type of content item associated with each of the sample content items and filters out textual content that does not provide a useful sample of the writing style of the user. For example, the greetings, complementary close, and signature lines of an email or letter are filtered out by the parsing and filtering unit 306 because these sections are generally standardized and provide little or no indication of the writing style of the user. Therefore, the remaining content included in the filtered content items should be indicative of the writing style of the user. The specific parts of each of the type of sample content items filtered out by the parsing and filtering unit 306 may vary based on the type of sample content item. The application services platform 110 provides a user interface that enables an administrator or other authorized user to define rules and/or templates for the filters to be utilized by the parsing and filtering unit 306. The parsing and filtering unit 306 may perform other formatting and filtering on the sample content items. The parsing and filtering unit 306 provides the sample content items to the request processing unit 122, and the request processing unit 122 provides the sample content items to the prompt construction unit 124.

FIG. 4 is a diagram showing additional features of the prompt construction unit 124 of the application services platform shown in FIG. 1. The prompt construction unit formats the prompt for the language model 126 and submits the prompt to the language model 126. The prompt construction unit 124 includes a prompt formatting unit 402 and a prompt submission unit 406.

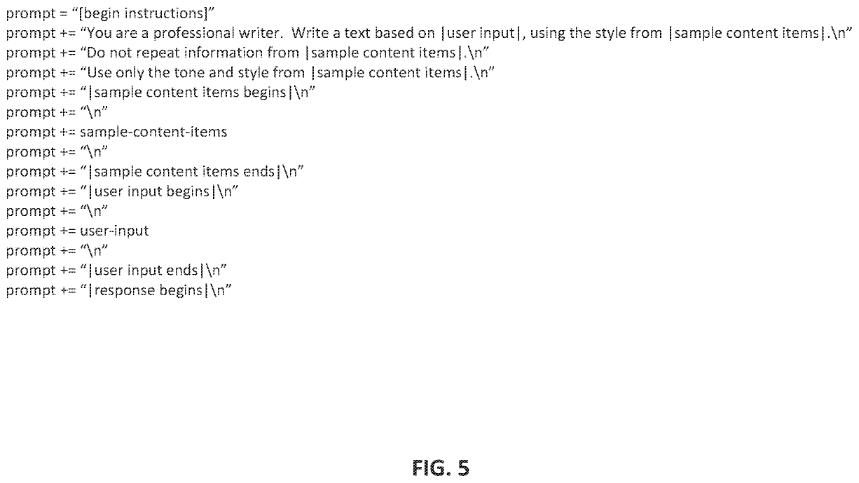

The prompt construction unit 124 receives the natural language prompt input by the user and the sample content items output by the sample content unit 134. The prompt construction unit 124 formats the prompt according to a prompt template and includes the natural language prompt and at least a portion of the sample content items in the textual content of the prompt. FIG. 5 provides an example of a prompt template that may be used by the prompt construction unit 124 in some implementations. The prompt template includes instructions that guide the language model 126 regarding the textual content to be generated. The example prompt in FIG. 5 instructs the language model 126 not to repeat information included in the sample content and to use only the tone and style from the sample content when generating the textual content. Other implementations may include instructions in addition to and/or instead of one or more of these instructions. Furthermore, the specific format of the prompt may differ in other implementations.

In some implementations, the prompt construction unit 124 selects from among multiple prompt templates. In such implementations, the prompt construction unit 124 analyzes the natural language prompt using a second language model trained to analyze a textual input and to classify the subject matter of the textual input into one of a predetermined set of categories. Each category is associated with a respective prompt template. The prompt construction unit 124 submits the natural language prompt to the second language model to obtain a predicted category and then selects the appropriate prompt template to be used to construct the prompt.

The prompt construction unit 124 submits the formatted prompt to the moderation services 168 to ensure that the prompt does not include any potentially objectionable or offensive content. The prompt construction unit 124 halts the processing of the prompt in response to the moderation services 168 determining that the prompt includes potentially objectionable or offensive content. As discussed in the preceding examples, the moderation services 168 generates a blocked content notification in response to determining that the prompt includes potentially objectionable or offensive content, and the notification is provided to the native application 114 or the web application 190 so that the notification can be presented to the user on the client device 105. The user may attempt to revise and resubmit the natural language prompt.

The prompt submission unit 406 submits the formatted prompt to the language model 126. The language model 126 analyzes the prompt and generates a response based on the prompt. The prompt submission unit 406 submits the response generated by the language model to the moderation services 168 to ensure that the response does not include any potentially objectionable or offensive content. The prompt construction unit 124 halts the processing of the response in response to the moderation services 168 determining that the prompt includes potentially objectionable or offensive content. The moderation services 168 generates a blocked content notification in response to determining that the generated content includes potentially objectionable or offensive content, and the notification is provided to the native application 114 or the web application 190 so that the notification can be presented to the user on the client device 105. The user may attempt to revise and resubmit the natural language prompt. If the moderation services 168 does not identify any issues with the generated content output by the language model 126 in response to the prompt, the prompt submission unit 406 provides the generated output to the request processing unit 122. The request processing unit 122 the provides the generated content to the native application 114 or the web application 190 depending upon which application was the source of the request to generate content.

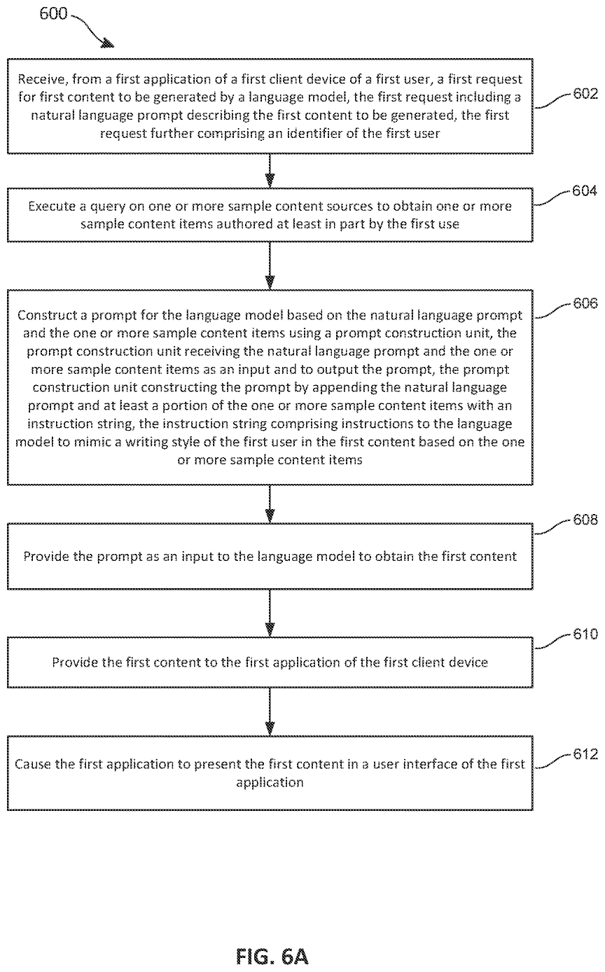

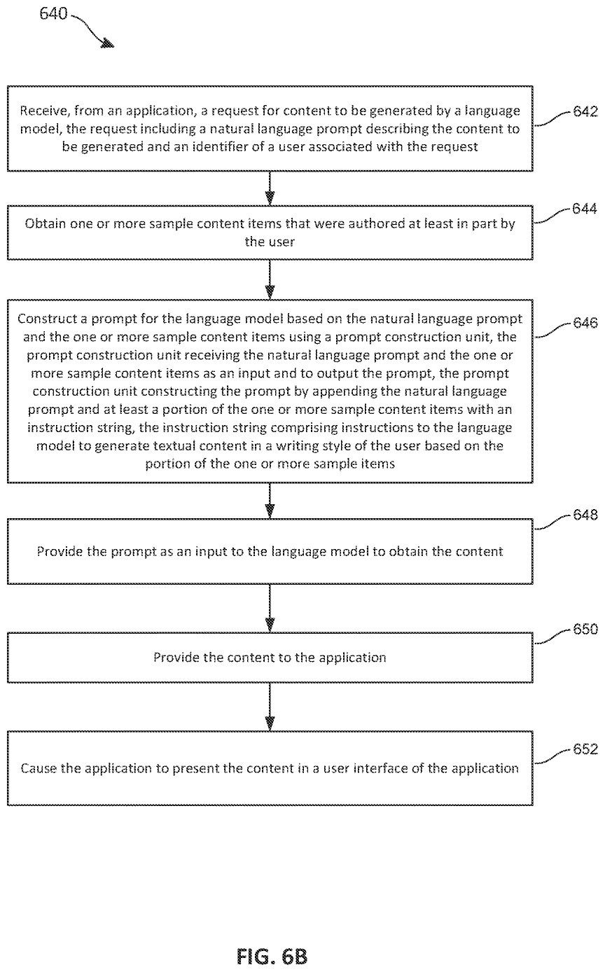

FIG. 6A is a flow chart of an example process 600 for using generative AI to create textual content that mimics the writing style of a specific user according to the techniques disclosed herein. The process 600 can be implemented by the application services platform 110 shown in the preceding examples.

The process 600 includes an operation 602 of receiving, from a first application of a first client device of a first user, a first request for first content to be generated by a language model, the first request including a natural language prompt describing the first content to be generated, the first request further comprising an identifier of the first user. The first application is implemented by the native application 114 in some implementations. In other implementations, the first application is the browser application 112, and the user accesses the web application 190 from the application services platform 110 using the browser application 112. As discussed in the preceding examples, the first user may input the natural language prompt in the prompt field of the user interface 205 shown in FIGS. 2A-2C.

The process 600 includes an operation 604 of executing a query on one or more sample content sources to obtain one or more sample content items authored at least in part by the first user. The sample content unit 134 queries the sample content sources 136 to obtain the sample content items that were authored by the user to provide samples of the writing style of the user that the language model 126 can mimic in the content generated by the language model 126. The language model 126 emulates the tone, word choices, sentence structure, and/or other stylistic aspects of the sample content items in the content generated by the model.

The process 600 includes an operation 606 of constructing a prompt for the language model based on the natural language prompt and the one or more sample content items using a prompt construction unit, and an operation 608 of providing the prompt as an input to the language model to obtain the first content. The prompt construction unit 124 is configured to receive the natural language prompt and the one or more sample content items as an input and to output the prompt. The prompt construction unit 124 is configured to construct the prompt by appending the natural language prompt and at least a portion of the one or more sample content items with an instruction string. The instruction string includes instructions to the language model to mimic a writing style of the first user in the first content based on the one or more sample content items.

The prompt instructs the language model to mimic the writing style of the first user in the first content based on the one or more sample content items. As discussed in the preceding examples, the prompt construction unit 124 constructs a prompt that instructs the language model to not repeat information from the sample content items in the generated textual content and to emulate only the tone and style from the sample content items in the generated content. A technical benefit of this approach is that the generated textual content better reflects the writing style of the user than the generic writing style that is typically reflected in content generated by a language model, such as the language model 126. The language model 126 analyzes the prompt, which includes the natural language prompt provided by the user and the sample content items, to generate the content requested in the natural language prompt according to the writing style of the first user.

The process 600 includes an operation 610 of providing the first content to the first application of the first client device and an operation 612 of causing the first application to present the first content in a user interface of the first application. The request processing unit 122 provides the content generated by the language model 126 in response to the prompt to the native application 114 or the web application 190. The application then updates the user interface, such as the user interface 205, to present the generated content to the user.

FIG. 6B is a flow chart of another example process 640 for using generative AI to create textual content that mimics the writing style of a specific user according to the techniques disclosed herein. The process 640 can be implemented by the application services platform 110 shown in the preceding examples.

The process 640 includes an operation 642 of receiving, from an application, a request for content to be generated by a language model, the request including a natural language prompt describing the content to be generated and an identifier of a user associated with the request. The application is implemented by the native application 114 in some implementations and the browser application 112 in other implementations. The user accesses the web application 190 from the application services platform 110 using the browser application 112. As discussed in the preceding examples, the first user may input the natural language prompt in the prompt field of the user interface 205 shown in FIGS. 2A-2C.

The process 640 includes an operation 644 of obtaining one or more sample content items that were authored at least in part by the user. The sample content unit 134 accesses the sample content sources 136 to obtain the sample content items that were authored by the user to provide samples of the writing style of the user such that the language model 126 can mimic the writing style in the content generated by the language model 126. The language model 126 emulates the tone, word choices, sentence structure, and/or other stylistic aspects of the sample content items in the content generated by the model.

The process 640 includes an operation 646 of constructing a prompt for the language model based on the natural language prompt and the one or more sample content items using a prompt construction unit and an operation 648 of providing the prompt as an input to the language model to obtain the content. The prompt construction unit 124 is configured to receive the natural language prompt and the one or more sample content items as an input and to output the prompt as discussed in the preceding examples. The prompt construction unit 124 is configured to construct the prompt by appending the natural language prompt and at least a portion of the one or more sample content items with an instruction string. The instruction string includes instructions to the language model 126 to generate textual content in a writing style of the user based on the portion of the one or more sample items.

The process 640 includes an operation 650 of providing the content to the application and an operation 652 of causing the application to present the content in a user interface of the application. The request processing unit 122 provides the content generated by the language model 126 in response to the prompt to the native application 114 or the web application 190. The application then updates the user interface, such as the user interface 205, to present the generated content to the user.

The detailed examples of systems, devices, and techniques described in connection with FIGS. 1-6 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-6 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

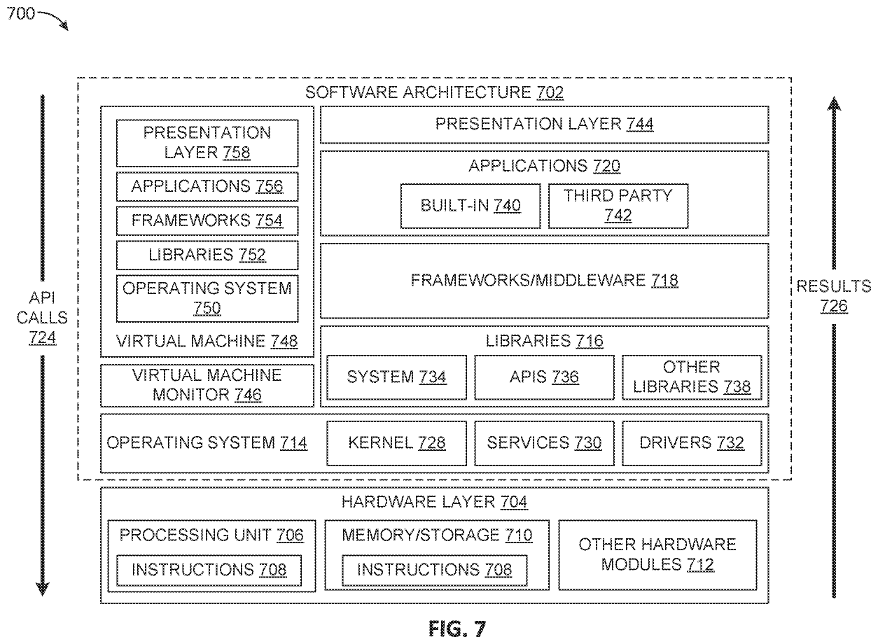

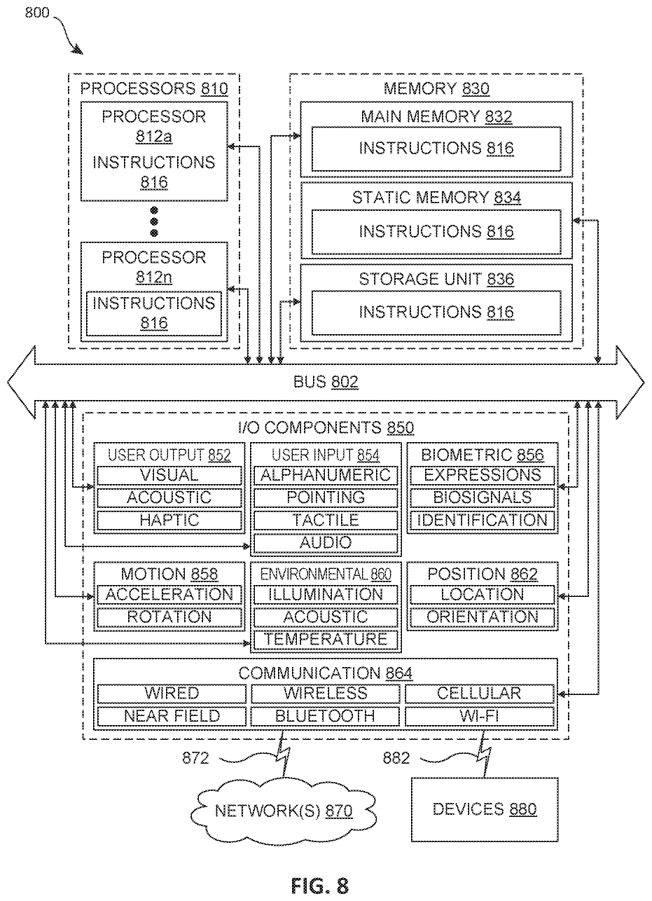

FIG. 7 is a block diagram 700 illustrating an example software architecture 702. various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory 830, and input/output (I/O) components 850. A representative hardware layer 704 is illustrated and can represent, for example, the machine 800 of FIG. 8. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks 718 (also sometimes referred to as middleware) provide a higher-level common infrastructure that may be used by the applications 720 and/or other software modules. For example, the frameworks 718 may provide various graphic user interface (GUI) functions, high-level resource management, or high-level location services. The frameworks 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed. As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated. the term “machine” includes a collection of machines that individually or jointly execute the instructions 816.

The machine 800 may include processors 810, memory 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multi-core processor including cores that may execute instructions contemporaneously. Although FIG. 8 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on, The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising.” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a machine-readable storage medium storing executable instructions that, when executed, cause the processor alone or in combination with other processors to perform operations of:
receiving, from a first application of a first client device of a first user, a first request for first content to be generated by a language model, the first request including a natural language prompt describing the first content to be generated, the first request further comprising an identifier of the first user;
executing a query on one or more sample content sources to obtain one or more sample content items authored at least in part by the first user;
constructing a prompt for the language model based on the natural language prompt and the one or more sample content items using a prompt construction unit, the prompt construction unit receiving the natural language prompt and the one or more sample content items as an input and to output the prompt, the prompt construction unit constructing the prompt by appending the natural language prompt and at least a portion of the one or more sample content items with an instruction string, the instruction string comprising instructions to the language model to mimic a writing style of the first user in the first content based on the one or more sample content items;
providing the prompt as an input to the language model to obtain the first content;
providing the first content to the first application of the first client device; and
causing the first application to present the first content in a user interface of the first application.

2. The data processing system of claim 1, wherein mimicking the writing style of the first user includes mimicking a tone, word choices, sentence structure, or a combination thereof of the one or more sample content items.

3. The data processing system of claim 1, wherein the machine-readable storage medium further includes instructions configured to cause the processor alone or in combination with other processors to perform operations of:
ranking the sample content items according to how recently the sample content items were created and a length of the sample content items, wherein more recent and longer sample content items are ranked higher than less recent and shorter sample content items.

4. The data processing system of claim 3, wherein the machine-readable storage medium further includes instructions configured to cause the processor alone or in combination with other processors to perform operations of:
parsing the sample content items to determine a content type associated with each of the sample content items; and
filtering the sample content items based on the content types associated with each of the sample content items to generate filtered content items, wherein filtering a respective content item of the sample content items includes removing sections of the respective content item that are not indicative of the writing style of the user, and
wherein constructing the prompt for the language model further comprises constructing the prompt based on the natural language prompt and the filtered content items.

5. The data processing system of claim 1, wherein constructing the prompt for the language model further comprises:
formatting the natural language prompt and the one or more sample content items using a prompt template that defines a layout of the prompt for the language model, the prompt template including instructions to the language model to mimic the writing style of the first user in the first content based on the one or more sample content items.

6. The data processing system of claim 5, wherein the machine-readable storage medium further includes instructions configured to cause the processor alone or in combination with other processors to perform operations of:
analyzing the natural language prompt to determine a subject matter of the natural language prompt; and
selecting the prompt template from among a plurality of prompt templates based on the subject matter of the natural language prompt.

7. The data processing system of claim 1, wherein the machine-readable storage medium further includes instructions configured to cause the processor alone or in combination with other processors to perform operations of:
analyzing the natural language prompt using a content moderation service to predict whether the natural language prompt includes objectionable subject matter; and
rejecting the natural language prompt responsive to predicting that the natural language prompt includes objectionable subject matter.

8. The data processing system of claim 1, wherein the machine-readable storage medium further includes instructions configured to cause the processor alone or in combination with other processors to perform operations of:
analyzing the sample content items using a content moderation service to predict whether the sample content items include objectionable subject matter; and
discarding the sample content items responsive to predicting that the sample content items include objectionable subject matter.

9. The data processing system of claim 1, wherein the machine-readable storage medium further includes instructions configured to cause the processor alone or in combination with other processors to perform operations of:
analyzing the first content using a content moderation service to predict whether the first content includes objectionable subject matter; and
rejecting the first content responsive to predicting that the first content includes objectionable subject matter.

10. A method implemented in a data processing system for creating textual content that mimics a writing style of a specific user, the method comprising:
receiving, from a first application of a first client device of a first user, a first request for first content to be generated by a language model, the first request including a natural language prompt describing the first content to be generated, the first request further comprising an identifier of the first user;
executing a query on one or more sample content sources to obtain one or more sample content items authored at least in part by the first user;
constructing a prompt for the language model based on the natural language prompt and the one or more sample content items using a prompt construction unit, the prompt construction unit receiving the natural language prompt and the one or more sample content items as an input and to output the prompt, the prompt construction unit constructing the prompt by appending the natural language prompt and at least a portion of the one or more sample content items with an instruction string, the instruction string comprising instructions to the language model to mimic a writing style of the first user in the first content based on the one or more sample content items;
providing the prompt as an input to the language model to obtain the first content;
providing the first content to the first application of the first client device; and
causing the first application to present the first content in a user interface of the first application.

11. The method of claim 10, wherein mimicking the writing style of the first user includes mimicking a tone, word choices, sentence structure, or a combination thereof of the one or more sample content items.

12. The method of claim 10, further comprising:
ranking the one or more sample content items according to how recently the sample content items were created and a length of the sample content items, wherein more recent and longer sample content items are ranked higher than less recent and shorter sample content items.

13. The method of claim 12, further comprising:
parsing the one or more sample content items to determine a content type associated with each of the sample content items; and
filtering the one or more sample content items based on the content types associated with each of the sample content items to generate filtered content items, wherein filtering a respective content item of the sample content items includes removing sections of the respective content item that are not indicative of the writing style of the user, and
wherein constructing the prompt for the language model further comprises constructing the prompt based on the natural language prompt and the filtered content items.

14. The method of claim 10, wherein constructing the prompt for the language model further comprises:
formatting the natural language prompt and the one or more sample content items using a prompt template that defines a layout of the prompt for the language model, the prompt template including instructions to the language model to mimic the writing style of the first user in the first content based on the one or more sample content items.

15. The method of claim 14, further comprising:
analyzing the natural language prompt to determine a subject matter of the natural language prompt; and
selecting the prompt template from among a plurality of prompt templates based on the subject matter of the natural language prompt.

16. The method of claim 10, wherein executing the query on one or more sample content sources to obtain the one or more sample content items further comprises:
querying a graph comprising enterprise-specific information associated with the user to obtain the one or more sample content items.

17. A data processing system comprising:
a processor; and
a machine-readable storage medium storing executable instructions that, when executed, cause the processor alone or in combination with other processors to perform operations of:
receiving, from an application, a request for content to be generated by a language model, the request including a natural language prompt describing the content to be generated and an identifier of a user associated with the request;
obtaining one or more sample content items that were authored at least in part by the user;
constructing a prompt for the language model based on the natural language prompt and the one or more sample content items using a prompt construction unit, the prompt construction unit receiving the natural language prompt and the one or more sample content items as an input and to output the prompt, the prompt construction unit constructing the prompt by appending the natural language prompt and at least a portion of the one or more sample content items with an instruction string, the instruction string comprising instructions to the language model to generate textual content in a writing style of the user based on the portion of the one or more sample items;
providing the prompt as an input to the language model to obtain the content;
providing the content to the application; and
causing the application to present the content in a user interface of the application.

18. The data processing system of claim 17, wherein mimicking the writing style of the first user includes mimicking a tone, word choices, sentence structure, or a combination thereof of the one or more sample content items.

19. The data processing system of claim 17, wherein the machine-readable storage medium further includes instructions configured to cause the processor alone or in combination with other processors to perform operations of:
ranking the one or more sample content items according to how recently the sample content items were created and a length of the sample content items, wherein more recent and longer sample content items are ranked higher than less recent and shorter sample content items.

20. The data processing system of claim 19, wherein the machine-readable storage medium further includes instructions configured to cause the processor alone or in combination with other processors to perform operations of:
parsing the one or more sample content items to determine a content type associated with each of the sample content items; and
filtering the one or more sample content items based on the content types associated with each of the sample content items to generate filtered content items, wherein filtering a respective content item of the sample content items includes removing sections of the respective content item that are not indicative of the writing style of the user, and
wherein constructing the prompt for the language model further comprises constructing the prompt based on the natural language prompt and the filtered content items.
